(19) United States
(12) Patent Application Publication
(10) Pub. No.: US 2014/0249890 A1
(43) Pub. Date: Sep. 4, 2014

(54) SYSTEM AND METHOD OF STRATEGIC LEARNING

(71) Applicant: Jewlya Lynn, Denver, CO (US)

(72) Inventor: Jewlya Lynn, Denver, CO (US)

(73) Assignee: The Center for Systems Integration d/b/a Spark Policy Institute, Denver, CO (US)

(21) Appl. No.: 13/782,961

(22) Filed: Mar. 1, 2013

(51) Int. Cl. G06Q 10/06

(52) U.S. Cl. CPC G06Q 10/0639
USPC 705/7.38

(57) ABSTRACT

The present invention provides a system and method of strategic learning and, in particular, to a system and method that allows evaluation to occur in real-time, shifts evaluation from the researcher to the program manager, and provides a feedback loop regarding evaluation findings. In one embodiment, the method comprises steps of: 1) learning preparation, wherein a team is established to implement a model, 2) roadmap development, wherein tangible outcomes are created and identified, 3) focused learning, wherein a plurality of outcomes from step 2) are identified and then considered critical, 4) systematic data collection wherein one asks how to collect data that is meaningful, and 5) strategies improvement, wherein data collection is used to change strategy.

### FIELD OF THE INVENTION

Embodiments of the present invention are generally related to a system and method of strategic learning and, in particular, to a system and method that allows evaluation to occur in real-time, shifts evaluation from the researcher to the program manager, and provides a feedback loop regarding evaluation findings.

### BACKGROUND OF THE INVENTION

For many people, strategic learning is an idea or a phrase, perhaps something they want to pursue, but often something that is hard to define. For some people, it is part of what they do day to day, but they have a hard time saying what exactly it means or replicating it across different projects.

As a concept, strategic learning is an intraorganizational ecological process that integrates different types of learning in organizations and includes processes for both creating knowledge about strategy and refining it. See K. Kuwada, “Strategic learning: The continuous side of discontinuous strategic change”, 1998. It encompasses many types of learning that fosters knowledge and that leads to differences in organizational performance. See J. B. Thomas, et al., “Understanding “Strategic Learning”: Linking organizational learning, knowledge management, and sensemaking”, 2001. See Organization Science, “Strategic learning as a practice can be found in the approaches of evaluators and organizations undertaking evaluation where it can be a tool for real-time improvements as strategies are developed”. See M. Q. Patton, “Developmental evaluation: Applying complexity concepts to enhance innovation and use”, 2011. Strategic learning in both concept and practice is perhaps best brought together by action research, which solves a problem using a cyclical process that moves between the pursuit of change through action, and new understanding through research. See, for example, B. Dick, “What is Action Research?”, 1999.

Most definitions of strategic learning feature two core elements: (1) learning: the systematic use of data for continuous improvement and the collective interpretation of new information, and (2) being strategic: applying the collective interpretation of information to strategy. What is not included in many definitions, but is arguably critical if the learning is to move from intuitive to strategic, is: (3) utilizing theory and research to ground both strategy and learning in a broader context of what is known about the world.

What is needed is a system and method for strategic learning that allows evaluation to occur in real-time, shifts evaluation from the researcher to the program manager, and provides a feedback loop regarding evaluations.

The prior art does not address this need. For example, U.S. Patent Application Publication No. 2006/0100897 to Halloran, Jr. (“Halloran”) discloses a system for assessing the level of social responsibility of a business and for monitoring improvements using the assessed level as a baseline. The system includes a self-assessment testing method which establishes a score or “grade” indicative of the level of social responsibility of the business which can be used for comparative purposes internally or externally. In terms of a business entity, Halloran provides for a self-assessment process to objectively determine the level of social responsibility of the company in a manner subject to outside verification. The process isolates components of social responsibility. The results permit precise decision making implementing change and reevaluation. The process results in a score or grade that is subject to verification or auditing by an outside agency in order that it will be a meaningful assessment outside of the confines of the company and in a broader community. However, Halloran focuses only on a social responsibility result for a corporate entity, and does not, among other things, allow tailoring to a particular organization's goals. Halloran is incorporated by reference in its entirety.

U.S. Pat. No. 6,708,155 to Honarvar (“Honarvar”) discloses an apparatus and method for automatically optimizing a strategy of a decision management system. More specifically, a computer-implemented decision management system applies a strategy to determine actions to be taken, monitors performance based on the taken actions, and refines the strategy in accordance with the monitored performance. An end user of the system selects a part of the strategy for optimization, and selects criteria for optimizing the selected part of the strategy. The decision management system then automatically optimizes the selected part of the strategy in accordance with the selected criteria. The end user can decide whether or not to implement the optimized strategy in production. Honarvar, however, requires its performance monitoring metrics to be static rather than dynamic and is thus unable to change with strategy modifications. Honarvar is incorporated by reference in its entirety.

U.S. Patent Application Publication No. 2011/0318716 to Higgins et al. (“Higgins”) discloses learning solutions and related methods for managing the learning and training needs of an organization in a manner that is responsive to dynamic business timelines, goals and strategic objectives. Business goals are determined through examination of existing business data sources, so as to tailor learning solutions to business impacts. Accurate computations of return on training investment are provided to allow accurate assessment of the effectiveness of training programs. Also disclosed are networks of learning platforms that together implement the learning solution by providing electronic tools and information sharing capabilities needed by a learning solution services provider to efficiently implement and manage learning efforts according to the business desires of a complex learner organization, while receiving organization performance data in order to compute and report performance measurements. Higgins, however, is focused on measuring effectiveness, rather than a larger integrated system and method to effect strategic learning. Higgins is incorporated by reference in its entirety.

The non-patent publication by Eric Kong (“Kong”) entitled “The Development of Strategic Management in the Non-Profit Context: Intellectual Capital in Social Service Non-Profit Organizations,” 2007 discloses strategic management methods appropriate for the pursuit of non-profit activities with particular emphasis on Social service nonprofit organizations (SSNPOs). Kong presents a fairly rigid “score card” measure of effectiveness with emphasis on comparability over time, rather than the present invention which, among other things, measures against what you need to know now based upon real-time monitoring. As such, Kong is unable to adapt to changes in strategy. Kong is incorporated by reference in its entirety.

By way of providing additional background and context, the following references are incorporated by reference in their entireties for the purpose of explaining strategic learning and to further describe the various tools and other apparatus commonly associated therewith:

The non-patent publication by Dorothea Greiling (“Greiling”) entitled “Performance Measurement Systems in Non-profit Organizations as Management Tool or an Option for Strategic Responses?” published in 2011 discloses empirical results concentrated on German health and social care providers.

International Pub. No. WO97/31320 to Yeates (“Yeates”) discloses improvements in systemizing a range of management processes that are undertaken in the normal course of operating a business, organization or a network of businesses or organizations.

U.S. Pat. No. 7,340,409 to Ulwick (“Ulwick”) discloses a computer program product for use with a computer system for providing a process for strategy evaluation and optimization, having a computer-readable medium of instructions for directing a computer to evaluate data for optimizing strategic options. The product includes data storage relating to specific desired outcomes relating to a specific process for an identified customer set and data relating to metrics which predict the satisfaction of desired outcomes. The process has a computer program for quantifying the degree to which each metric predicts satisfaction of each customer desired outcome. Users define strategic options; each option is designed to satisfy customer desired outcomes. A computer program quantifies the degree to which each strategic option satisfies customer desired outcomes.

The non-patent publication published by JSTOR (“JSTOR”) 2007 entitled “Understanding Strategic Learning: Linking Organizational Learning, Knowledge Management, and Sensemaking” discloses a model for strategic learning.

U.S. Patent Application Publication No. 2004/0024715 to Ouimet (“Ouimet”) discloses a software method for controlling the optimization of a planning model that uses historical sales data to predict optimal prices and similar factors for meeting a number of business goals. The system allows the analysis of the costs and benefits of such management imposed strategic objectives.

U.S. Patent Application Publication No. 2010/0100499 to Lele (“Lele”) discloses a system for optimization of production with added value and for integration of the best business practices.

U.S. Patent Application Publication No. 2010/0217652 to Brooks Rix (“Rix”) discloses a system that automates workforce management tasks through the integrated use of structured content accessible from a database, a set of business logic rules engines as well as input from users via user interfaces.

U.S. Patent Application Publication No. 2012/0263291 to Zernik (“Zernik”) discloses a call center system with optimizing rules enforced over interactions with customers.

U.S. Pat. No. 8,260,627 to Davidson (“Davidson”) discloses a system and method for determining business partner value by creating weighted metrics for identifying, evaluating and selecting a business partner for a company; creating a business agreement and weighted metrics for evaluating the agreement; creating weighted metrics for ongoing management of the partner; and managing the partner by ongoing periodic evaluation of the weighted metrics for partner selection, agreement, and management.

U.S. Pat. No. 8,275,644 to Cases et al. (“Cases”) discloses techniques for optimizing a Business process Model (BPM) having at least one work process.

These approaches do not address strategic learning and, in particular, to a system and method that allows evaluation to occur in real-time, shifts evaluation from the researcher to the program manager, and provides a feedback loop regarding evaluations. Such features are not present in the art. Therefore, there is a long-felt need for a system and method of strategic learning and, in particular, to a system and method that allows evaluation to occur in real-time, shifts evaluation from the researcher to the program manager, and provides a feedback loop regarding evaluations. The present device and method of operation addresses and solves these needs.

### SUMMARY OF THE INVENTION

It is one aspect of the present invention to provide a system and method of strategic learning and, in particular, to a system and method that allows evaluation to occur in real-time, shifts evaluation from the researcher to the program manager, and provides a feedback loop regarding evaluations. In one embodiment of the invention, the method comprises steps of: 1) learning preparation, wherein a team is established to implement a model, 2) roadmap development, wherein tangible outcomes are created and identified, 3) focused learning, wherein a plurality of outcomes from step 2) are identified as critical, 4) systematic data collection wherein one asks how to collect data that is meaningful, and 5) strategies improvement, wherein data collection is used to change strategy.

In a one embodiment of the invention, a method for strategic learning is disclosed, the method comprising: preparing a strategic learning environment by assembling a learning team, identifying a plurality of initial strategies and initial outcomes, and reviewing existing research relative to the initial strategies; developing a strategic learning roadmap by refining the initial strategies and initial outcomes based on at least the existing research and through use of the learning team, wherein refined strategies and refined outcomes are created; focusing the roadmap by identifying at least one refined outcome as a critical outcome; collecting data, the data at least comprising a measure of at least one critical outcome; and interpreting the data by assessing the data through use of the learning team, wherein at least one of the refined strategies of the strategic learning roadmap may selectably be further refined.

In another embodiment of the invention, a system for strategic learning is disclosed, the system comprising: a strategic learning module wherein a learning team is assembled, a plurality of initial strategies and initial outcomes are identified, and existing research relative to the initial strategies are reviewed; a roadmap development module wherein a strategic learning roadmap is developed, the roadmap comprising refined initial strategies and refined initial outcomes based on the existing research, wherein the refined strategies and refined outcomes are created; a focused learning module wherein at least one refined outcome as a critical outcome is identified; a data collection module wherein data is collected, the data at least comprising a measure of at least one critical outcome; and a strategy improvement module wherein interpreting the data is assessed through use of the learning team and a strategic learning debrief, wherein at least one of the refined strategies of the strategic learning roadmap is further refined.

In yet another embodiment of the invention, a method for strategic learning for a social good is disclosed, the method comprising: preparing a strategic learning environment by assembling a learning team, identifying a plurality of initial strategies and initial outcomes, and reviewing existing research relative to the initial strategies; developing a strategic learning roadmap by refining the initial strategies and initial outcomes based on at least the existing research and through use of the learning team, wherein refined strategies and refined outcomes are created; focusing the roadmap by identifying at least one refined outcome as a critical outcome; collecting data, the data at least comprising a measure of at least one critical outcome; and interpreting the data by assessing the data through use of the learning team and through a strategic learning debrief, wherein at least one of the refined strategies of the strategic learning roadmap may selectably be further refined.

This Summary of the Invention is neither intended nor should it be construed as being representative of the full extent and scope of the present disclosure. The present disclosure is set forth in various levels of detail in the Summary of the Invention as well as in the attached drawings and the Detailed Description of the Invention, and no limitation as to the scope of the present disclosure is intended by either the inclusion or non-inclusion of elements, components, etc. in this Summary of the Invention. Additional aspects of the present disclosure will become more readily apparent from the Detailed Description, particularly when taken together with the drawings.

The above-described benefits, embodiments, and/or characterizations are not necessarily complete or exhaustive, and in particular, as to the patentable subject matter disclosed herein. Other benefits, embodiments, and/or characterizations of the present disclosure are possible utilizing, alone or in combination, as set forth above and/or described in the accompanying figures and/or in the description herein below. However, the Detailed Description of the Invention, the drawing figures, and the exemplary claims set forth herein, taken in conjunction with this Summary of the Invention, define the invention.

### BRIEF DESCRIPTION OF THE DRAWINGS

The accompanying drawings, which are incorporated in and constitute a part of the specification, illustrate embodiments of the disclosure and together with the general description of the disclosure given above and the detailed description of the drawings given below, serve to explain the principles of the disclosures.

FIG. 1 is a representation of the process of strategic learning;

FIG. 2 is a flow-chart of a method of strategic learning according to one embodiment of the invention;

FIG. 3A is a more detailed flow-chart of a sample implementation of one step of the method of strategic learning as provided in FIG. 2; and

FIGS. 3B-D are more detailed flow-charts of a sample implementation of a step of strategic learning as provided in FIG. 3A.

It should be understood that the drawings are not necessarily to scale. In certain instances, details that are not necessary for an understanding of the invention or that render other details difficult to perceive may have been omitted. It should be understood, of course, that the invention is not necessarily limited to the particular embodiments illustrated herein.

### DETAILED DESCRIPTION

The present invention provides a system and method of strategic learning and, in particular, to a system and method that allows evaluation to occur in real-time, shifts evaluation from the researcher to the program manager, and provides a feedback loop regarding evaluation findings. In one embodiment, the method comprises steps of: 1) learning preparation, wherein a team is established to implement a model, 2) roadmap development, wherein tangible outcomes are created and identified, 3) focused learning, wherein a plurality of outcomes from step 2) are identified and then considered critical, 4) systematic data collection wherein one asks how to collect data that is meaningful, and 5) strategies improvement, wherein data collection is used to change strategy.

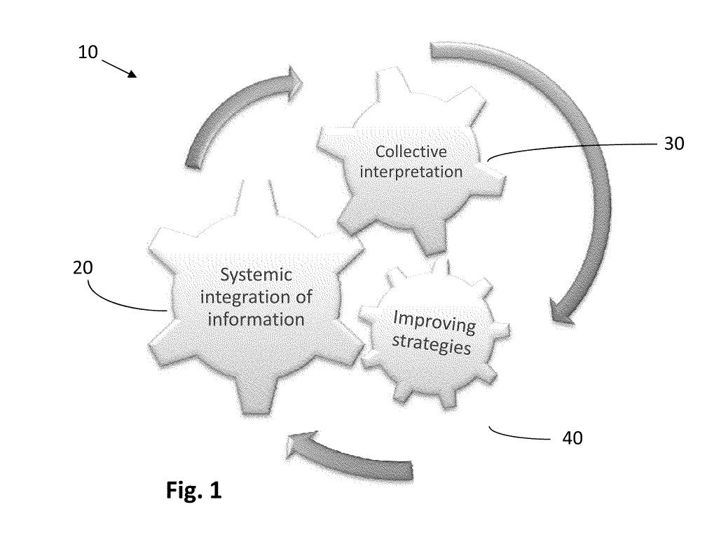

Referring now to FIG. 1, a representation of the process of strategic learning is presented. As a concept, strategic learning is an intraorganizational ecological process that integrates different types of learning in organizations and includes processes for both creating knowledge about strategy and refining it. See K. Kuwada, “Strategic learning: The continuous side of discontinuous strategic change”, 1998. It encompasses many types of learning that fosters knowledge and that leads to differences in organizational performance. See J. B. Thomas, et al., “Understanding “Strategic Learning”: Linking organizational learning, knowledge management, and sensemaking”, 2001. Strategic learning as a practice can be found in the approaches of evaluators and organizations undertaking evaluation where it can be a tool for real-time improvements as strategies are developed”. See M. Q. Patton, “Developmental evaluation: Applying complexity concepts to enhance innovation and use”, 2011. Strategic learning in both concept and practice is perhaps best brought together by action research, which solves a problem using a cyclical process that moves between the pursuit of change through action, and new understanding through research. See B. Dick, “What is action research?”, 1999.

Most traditional definitions of strategic learning feature two core elements: 1) Learning: the systematic use of data for continuous improvement and the collective interpretation of new information, and 2) Being strategic: Applying the collective interpretation of information to strategy. What is not included in many definitions, but is arguably critical if the learning is to move from intuitive to strategic, is: 3) Utilizing theory and research to ground both strategy and learning in a broader context of what is known about the world. These integrated three steps are shown in FIG. 1.

Grounding the strategic learning process in theory and research is a necessary step to move from learning based on assumptions to learning based on what is possible in reality. Often, organizations and individuals base their understanding of what they can accomplish—and what they learn about their accomplishments—on their own unspoken paradigms informed by past experiences. Even organizations that build logic models or theories of change to articulate their hypotheses about how change will happen sometimes do so without understanding what existing theory and research tell them about what is realistic. Without such a research base, strategic learning might feature systematic data collection, collective interpretation, and purposeful use of the learning, but still focus on intuitive ideas about what is possible and what matters in the broader environmental context, rather than on information that is most likely to improve the strategy to produce results.

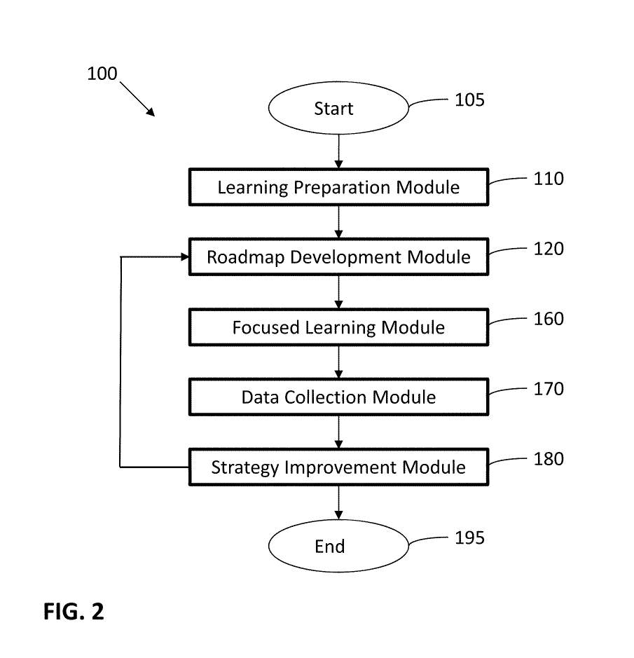

Referring now to FIG. 2, a flow-chart of a method of strategic learning according to one embodiment of the invention is presented.

Generally, a sequence of five steps through five modules is involved, as shown by FIG. 2. More specifically, the Strategic Learning System 100 method starts with a start operation 105 and ends with an end operation 195. The Strategic Learning System 100 can include more or fewer steps or can arrange the order of the steps differently than those shown in FIG. 2. Hereinafter, the Strategic Learning System 100 method shall be explained with reference to the systems, components, modules, software, data structures, user interfaces, etc. described in conjunction with FIGS. 1-3.

The method begins with the Start Step of Strategic Learning System 105. The method then proceeds to the Learning Preparation Module 110. Generally, processes and activities of the Learning Preparation Module 110 include preparing a strategic learning environment, such as assembling a learning team, identifying a plurality of initial strategies and initial outcomes, and reviewing existing research relative to the initial strategies. It is important that prior to beginning implementation of a strategic learning process, one clearly defines the big-picture strategies, defines the intermediary strategies that are intended for focus, and decide the membership for the Learning Team. Ideally, in one embodiment considered a best practice of strategic learning, within the Learning Preparation Module 110 one performs more than solely documenting one's best ideas about strategies and their outcomes, but additionally reviews existing research and models to identify what is truly achievable from the initial strategies. Generally, by selecting the right or proper research to guide the strategic learning, the environment for significant and meaningful improvements to one's strategy and outcomes is more fruitful. Thus, in one embodiment, the output of the Learning Preparation Module 110 is a set of initial strategies and initial outcomes. The Strategic Learning System 100 method then proceeds to the Roadmap Development Module 120.

Generally, in the Roadmap Development Module 120 a strategic learning roadmap (“Roadmap”) is developed by refining the initial strategies and initial outcomes (of step 110). In one embodiment, the refinement of the initial strategies and/or initial outcomes is based on existing research and through use of a learning team. One output of the Roadmap Development Module 120 is a set of refined strategies and/or refined outcomes. In some embodiments, some or even most of the initial strategies and/or initial outcomes are left unchanged, i.e. they are not modified or refined. In one embodiment, during the Roadmap Development Module 120 strategies and desired outcomes are mapped out. Also, one applies identified research to validate that the strategies and/or outcomes are proper, e.g. realistic, realizable, and/or critical. It is noted that the identified research assists in understanding what a given strategy can realistically achieve, and the learning roadmap serves as a guiding document. Furthermore, Roadmaps may vary in character, i.e. some Roadmaps will be large and complex—covering many interrelated strategies. In other embodiments, the Roadmap will be simple, with one or two strategies and associated achievable outcomes.

In one embodiment, the Roadmap Development Module 120 adapts and specializes the traditional “Theory of Change (TOC)” tool. TOCs are commonly used by evaluators to clarify program logic and guide the evolution process and are sometimes also used for strategic planning. However, using TOCs specifically to support strategic learning requires some adaptation from how they are traditionally used. Theories of change (TOCs) are tools for developing solutions to complex social problems. Evaluators have recognized the importance of using theory-based evaluation for decades, and theories of change have developed as a tool for connecting program design, theory, and evaluation. In practice, a basic TOC explains the step-by-step process of how interim outcomes produce long-term results. A more complex TOC integrates the underlying assumptions informing that process, clarifying the ways in which interim outcomes contribute to desired long-term changes. Through a ‘backward mapping’ process from long-term to intermediate outcomes to actions taken today, an honest picture of the steps required to achieve impact is created, thereby informing strategic planning and evaluation. See A. Anderson, “The community builders approach to theory of change: A practical guide to theory and development”, 2005; See M. W. Lipsey, et al., “Driving toward theory in program evaluation: More models to choose from, Evaluation and Program Planning”, 1989.

Some evaluators believe that planning and implementation also can benefit from a well-developed theory of change. Rather than waiting until the end of a program, a TOC can facilitate the clear definition of goals during the design phase, and support data collection and measurement throughout a strategy's interim phases. A TOC is also the means by which a research base can be integrated with activities and their intended outcomes. At its best, the TOC is a clear description of activities and their relationship to outcomes, staged over time from the shortest-term outcomes to those that are dependent on multiple activities and previously accomplished outcomes. Ideally, each point in the TOC that transitions from an activity to an outcome is supported by research that indicates the intended strategy can lead to that outcome. Each outcome on the TOC is also supported by research that indicates the outcome is an important step on the road to desired long-term outcomes and impact.

Here, in one embodiment of the invention during the Roadmap Development Module 120 step of the Strategic Learning System 100, one adapts and advances the above traditional TOC by using the theory of change as a programmatic tool first and an evaluative tool second. The theory of change model departs from a focus on the measurable to developing a theory of what matters. In the process, the theory of change becomes not just a “common framework and shared vocabulary for stakeholders to understand and communicate the rationale and intended impact of strategies,” but also an ongoing planning tool to keep the focus on the strategy's intended impact. See jdcPartnerships, “Theory of change FAQ”, 2011.

To better articulate the invention's enhancement and modification of the traditional Theory of Change to create a Roadmap for use in strategic learning purposes in the Strategic Learning System 100, the next sections describe practical steps for: I) Design: ensuring the Roadmap design is led by program staff, informed by research, and results in a clearly defined roadmap, from activities to interim outcomes to long-term change, and II) Ongoing Use: making the Roadmap an ongoing planning document, allowing for and knowing when to change it, and using it to guide strategic learning.

I. Designing a Roadmap

If a strategy was not originally designed using a research base, the first step is background work to identify possible research frameworks and explore which is the best fit. For example, if a strategy addresses obesity prevention through nutrition and education programs, an ecological, behavioral, or psychological research framework might be used, or one that draws on two or three areas or other sources that articulate a clear connection between the nutrition and educational activities and the desired outcomes.

Once the research framework is established, the next step is convening key stakeholders to develop the Roadmap. This meeting should include, at minimum, a dedicated facilitator who is highly familiar with the research-based framework; staff including leadership; key outside stakeholders where appropriate; and a note taker. While the ideal model is to develop a Roadmap prior to designing a strategy, it is more common to see a Roadmap designed after some or all strategy elements have been completed. For example, a Roadmap might be developed after a grant has been awarded or after a strategy is underway. If any information already exists regarding the strategy and its desired outcomes, a well-prepared facilitator will bring that to the conversation as a starting point.

Roadmaps are visual representations of strategies and how activities link to a string of outcomes that result in the ultimate intended impact. For this reason, it is most effective to facilitate the dialogue using a visual presentation of information. Large sticky notes for each strategy and outcome, large white boards where information can be added and erased, or projections of onscreen Roadmap development all work well.

At the beginning, known activities and outcomes are displayed and participants are introduced to the research-based framework. Backward mapping from the long-term outcomes to the most immediate steps is a useful facilitation approach. However, if a strategy's activities are largely already defined, it often helps to switch between backward mapping and forward mapping to ensure the final Roadmap connects existing activities to intended long-term outcomes.

By the end of this process, the Roadmap should:
Clearly articulate strategy activities and the changes they are intended to cause, with a logical progression from early activities and changes to later ones. This staging is critical for the strategic learning process, as it introduces different learning needs at different points in time.
Identify plausible relationships between the activities and their desired outcomes based on the research framework. It can be helpful for meeting notes to include why each activity can achieve the desired outcomes, referring to the research. If participants feel uncertain about any of these relationships, follow-up work might be needed.
Describe both activities and outcomes to facilitate their day-to-day use. The Roadmap in this context helps to guide implementation. The process of doing a research-based Roadmap should, in and of itself, create a greater focus on refining activities to better achieve the change desired.

Finally, the Roadmap should include all meaningful steps in the pathway to change. When used strictly for evaluation purposes, a high-quality Roadmap should be testable. Its elements should all be measurable. When used for strategic learning, every element may not be measurable. It is more important to accurately describe the meaningful changes that a program hopes to accomplish, or the things that matter most, and identify later the extent to which they can be measured. The Roadmap should still feature a logical progression of outcomes that aligns with the research-based framework. But because the goal with strategic learning is the steady improvement of strategies, leaving off an important change in the world because it cannot be measured leaves room for strategies to lose focus on that change.

II. Using a Roadmap

In a strategic learning setting, a Roadmap can serve many purposes. Specific to guiding the learning process, the Roadmap becomes the tool for identifying where systematic data collection and collective interpretation and use of information will be most helpful. Whether focused on the quality of implementation or the resulting outcomes, the Roadmap guides the focus of strategic learning. It also helps program staff to identify when they want to use the learning, such as taking time to debrief about one set of activities and outcomes before moving to the next in their Roadmap.

Roadmaps can be used in many ways in strategic learning settings. Some uses are programmatic while others are more focused on the learning process. They can:
Serve as the structure for regular check-ins by program staff (and sometimes a strategic learning coach) to assess alignment of strategy activities with desired outcomes.
Guide the identification of where systematic data collection will be helpful, both in understanding what changes are occurring and understanding the influences on different Roadmap components.
Inform the design of strategy activities. If a new activity is being considered, the Roadmap should be reviewed to assess how the activity fits into the overall vision for what the strategy should accomplish.
Guide the structure of Strategic Learning Debriefs (see the next section), as data are gathered and summarized using worksheets that are based on the Roadmap. This ensures the discussion focuses on desired outcomes and the long-term vision for change, rather than recent issues or priorities that have bubbled up.
Educate new staff about the strategy.
Help new external partners or Board members understand how the many activities underway connect to a broader vision for change.

Roadmaps are living documents; strategies can change over time. These changes should be made with careful consideration for how the changes will influence what is accomplished in the long run. Sometimes changes are needed not only in activities, but also in desired outcomes. For example, for an advocacy organization, the strategy might shift from changing state policies to changing national policies, which would require both a change in the interim outcomes and a change in activities. The Strategic Learning System 100 method then proceeds to the Focused Learning Module 160.

Generally, in the Focused Learning Module 160 at least one refined outcome (of the roadmap) is identified as a critical outcome. Here, with aid of the roadmap, one can explore where to focus the strategic learning. For example, one might address queries such as: Is there a component of your strategy that is new for your organization? Are you expanding a strategy you've implemented before to a new population or setting?

Generally, one seeks the strategic learning to be focused on those things one most needs to know in order to improve, so as to not to waste time learning about something that is interesting, but not directly useful. As a general rule, one's strategic learning should tie directly back to the roadmap, and help one assess if one is achieving one's strategies and ultimately one's outcomes. The Strategic Learning System 100 method then proceeds to the Data Collection Module 170.

Generally, in the Data Collection Module 170, data is gathered, the data at least comprising a measure of at least one critical outcome. There are many tools for collecting data regarding, for example, the outcome of a given strategy, as known to those skilled in the art. Generally, when selecting a data collection tool, one should consider whether the tool will provide accurate information, insight into multiple perspectives, unbiased information, and information that is both useful and timely given what one wants to know and when one wants to know it. At this step in the Strategic Learning System 100 method it is desired be sure one has a plan for how to analyze and use the data collected to, for example, prevent an unwelcoming overwhelming amount of data that cannot be readily, efficiently or effectively analyzed. The Strategic Learning System 100 method then proceeds to the Strategy Improvement Module 180.

Generally, in the Strategy Improvement Module 180, the data collected in the Data Collection Module 170 is interpreted through use of a learning team, wherein at least one of the refined strategies of the strategic learning roadmap may selectably be further refined. Also, it is in the Strategy Improvement Module 180 where the Strategic Learning System 100 method moves from generally a planning process to an implementation process. In embodiments of the invention, during the Strategy Improvement Module 180 one may analyze or summarize data collected and prepare ways of presenting and talking about the with a Learning Team. The Learning Team may then take what they have learned and collectively interpret what it means for a given strategy, and use that learning to improve that particular strategy. In one embodiment, the step of interpreting the data occurs at least at one of an on-going basis, predefined items linked to milestones, and regular intervals; it may also occur in any such combination to include all three. Regardless of the manner in which the data are interpreted, a strategic learning debrief is a facilitation process to improve the strategic learning.

In one embodiment, during the Strategy Improvement Module 180, one or more of any identified critical outcomes may be determined to not be critical and/or one or more new or existing outcomes may be deemed critical.

Here, in one embodiment of the invention, the Strategy Improvement Module 180 step of the Strategic Learning System 100 adapts and advances the traditional Learning Debrief. Traditional Learning Debriefs are used as periodic debriefs to provide program implementers with updated evaluation findings.

Here, in this invention, traditional Learning Debriefs, which draw on the concept of evaluation presentations that are accompanied by reflection, are extended and adapted so as to build on proven practices for effective team-based dialogues for learning. Here, Strategic Learning Debriefs are an opportunity to purposefully and collectively:
Present and explore different types of learning in the context of the Roadmap, including systematic data collection and analysis and intuitive and experiential learning
Reflect on the learning and build a shared understanding of its implications
Apply the learning directly to the strategy and determine actions that need to be taken, whether changes in strategy or changes in learning.

Thus, Strategic Learning Debriefs differ from traditional evaluation presentation and accompanying dialogue in several ways. First, the concept of dialogue as articulated by proponents of learning organizations differs from traditional evaluation reflections through its emphasis on all participants, without prioritizing the role of an evaluator, researcher, or other lead “learner.” Here, dialogue is focused on “thinking together” and relies on participants who make a commitment to suspend their assumptions about each other and the strategy in order to have a more effective dialogue about what has been learned and its implications. See P. Senge, “The fifth discipline fieldbook: “Strategies and tools for building a learning organization”, 1994. The dialogue allows for discussion about both objective facts and subjective understanding, all within the context of interpersonal dynamics, which cannot help but influence the dialogue's content and quality. Because of these interpersonal dynamics, a facilitator is critical to a Strategic Learning Debrief, and is a role that is best filled by someone outside, but highly familiar with, the strategy. Debriefs also differ in how often they occur (at least every six months, if not more often, depending on the needs of the strategy); how data are presented and used (collective interpretation, rather than a presentation of completed findings); their use of experiential and intuitive learning; and their emphasis on leaving with new actions to take.

Here, in one embodiment, the Strategic Learning Debriefs component of the Strategy Improvement Module 180 is specifically not an opportunity for experts to present and facilitate a dialogue on their independent findings. While a researcher may be responsible for the systematic collection of data, a Strategic Learning Debrief collectively interprets and applies findings (which comes directly from the definition of strategic learning). Objectivity and independence, valued in many evaluation and research settings, are not treated as inherently valuable in the context of a Strategic Learning Debrief and might even become inhibitors to collective learning when the independent researcher is unable to let go of the power of owning the analysis leading up to the interpretation. Like action research, all participants are treated as equally important and the control often associated with a traditional researcher role is released. See Marti & Villasante, “Quality in action research: Reflections for second-order inquiry, Systemic Practice and Action Research,” 2009. Strategic Learning Debriefs are inherently internal processes (internal to the strategy, that is), where such things as accountability and documentation are not the focus. Rather, learning and improvement are paramount.

By way of example, and such examples are not intended to limit the invention, the following provides an example manner of implementing a Strategic Learning Debrief. In practice, a Strategic Learning Debrief is a two to three hour meeting with key staff directly involved in implementing the strategies along with other stakeholders (internal or external to the organization) who are invested in the strategy and familiar with its implementation. The meeting benefits greatly from a dedicated facilitator and note taker. Ideally, the facilitator is someone familiar with the strategy, but also not as invested as key staff in any decisions made.

Strategic Learning Debriefs require thoughtful preparation to be successful. Systematically collected information and findings need to be summarized and presented in an easily accessible way. Visual presentation is helpful, as is the use of stories and quotes to illustrate key findings. Staff responsible for presenting findings should be familiar enough with the information that they can bring key findings into the dialogue as issues arise. Rarely do Debriefs proceed in a linear and structured fashion that allows for each type of learning to be independently presented and explored. In fact, doing so would undermine the quality of a Strategic Learning Debrief, as it is a holistic examination of the strategy using systematically collected data.

Although Debriefs tend not to follow their agendas, it is still important to have a clear sense of what they hope to accomplish. Specific items to cover may include presentation on:
The Roadmap (or an update of it) to set the context
New learning about the environmental context
Completed activities, including learning about how they have been implemented
The outcomes occurring as a result of activities.

At the Debrief, the facilitator helps participants to review and discuss the strategy and learning. The discussion should explore the extent to which key staff and stakeholders completed activities and achieved desired outcomes. Before the Debrief ends, participants should identify lessons learned and make strategic decisions to be implemented before the next Debrief, including changes to the Roadmap, strategic learning tools, or specific strategy activities. The facilitator and note taker should generate a highly specific set of next steps that move the decisions made during the Debrief into actions. Staff are responsible for integrating those next steps into the strategy work plan and should assign responsibilities to complete them.

Ideally, each Strategic Learning Debrief will leave a “trail of evidence” for use in the future, primarily captured through comprehensive meeting notes. These notes allow any new staff person, future Debrief facilitators, or ongoing staff to review how and why decisions were made and will help to avoid the risk of repeating and cycling through the same set of issues without resolution.

The Strategic Learning System 100 then ends at the End Step of Roadmap Development Module 123.

### Case Example

By way of example, but noting that such scenarios are only some of many possible scenarios, the following sets forth a situation in which the group “We Want Healthcare” has a mission of achieving access to healthcare for everyone in their county. This case example is to illustrate how Theories of Change and Strategic Learning Debriefs can be used. It is based on a fictional nonprofit organization—We Want Healthcare—developed as a composite of actual nonprofit organizations that have engaged in strategic learning. These elements are common among all organizations from which the composite example is drawn. The example is developed with reference to FIGS. 1-3.

The organizational entity We Want Healthcare has decided to embed the Strategic Learning System 100 method into their new strategy to recruit advocates and host community forums.

This case example is to illustrate how a modified Theories of Change and Strategic Learning Debriefs can be used. It is based on a fictional nonprofit organization—We Want Healthcare—developed as a composite of actual nonprofit organizations that have. The group elects to:
Collect multiple forms of data systematically
Value and use both evaluative and non-evaluative data
Assign staff to collect and analyze data (and in some cases, an external evaluator is used)
Use a research framework to bound the understanding of the strategy and guide the learning
Engage multiple staff or external partners collectively in interpreting and using data
Apply strategic learning to changes in the implementation of their strategy.

We Want Healthcare's mission is to achieve access to healthcare for everyone countywide. As part of achieving their mission, this organization decided to embed strategic learning into their work by including internal staff in learning activities every week, hiring an evaluator when needed, and using an external strategic learning coach. In this example, as shown in FIG. 2, the method of the Strategic Learning System 100 begins with the Start Step of the Strategic Learning System 105 and then proceeds to the Learning Preparation Module 110.

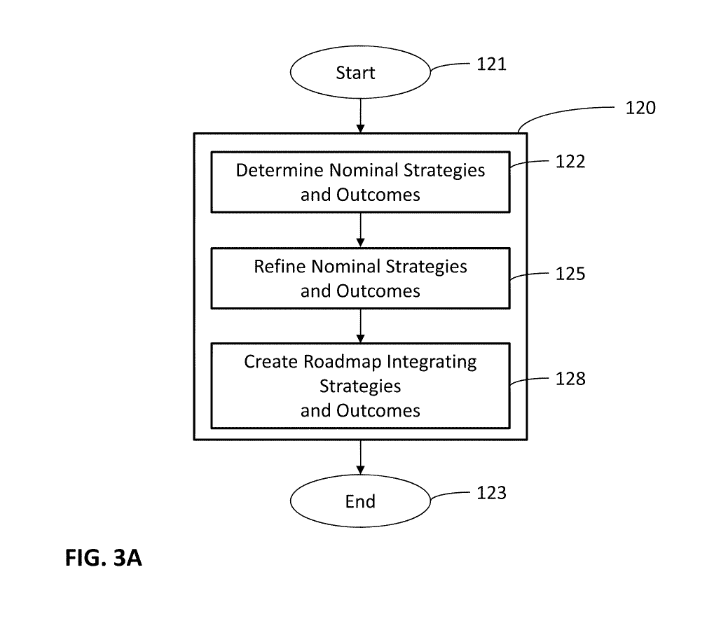

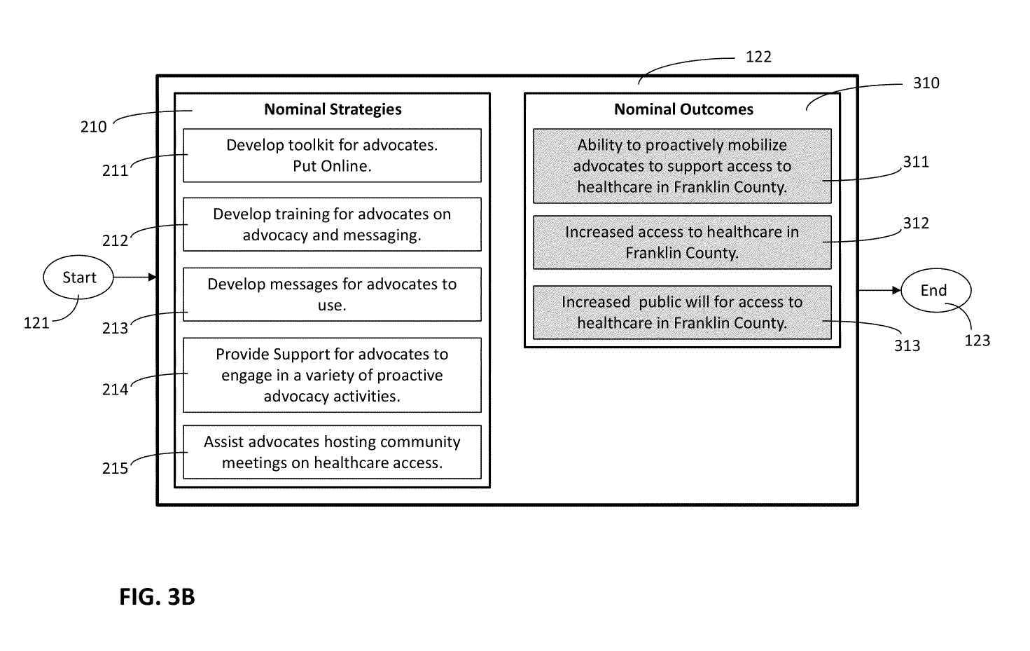

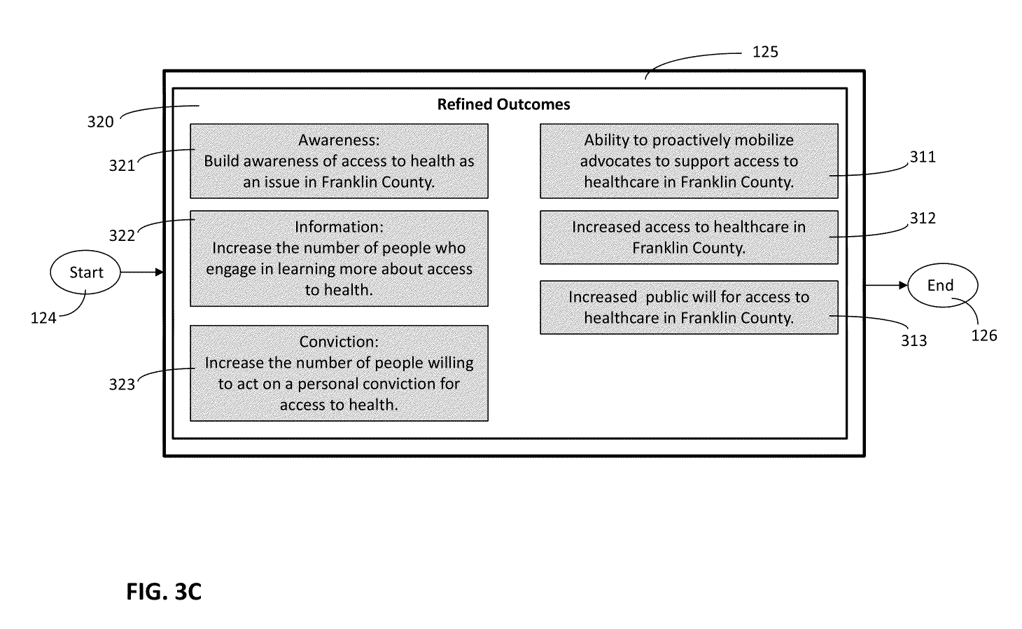

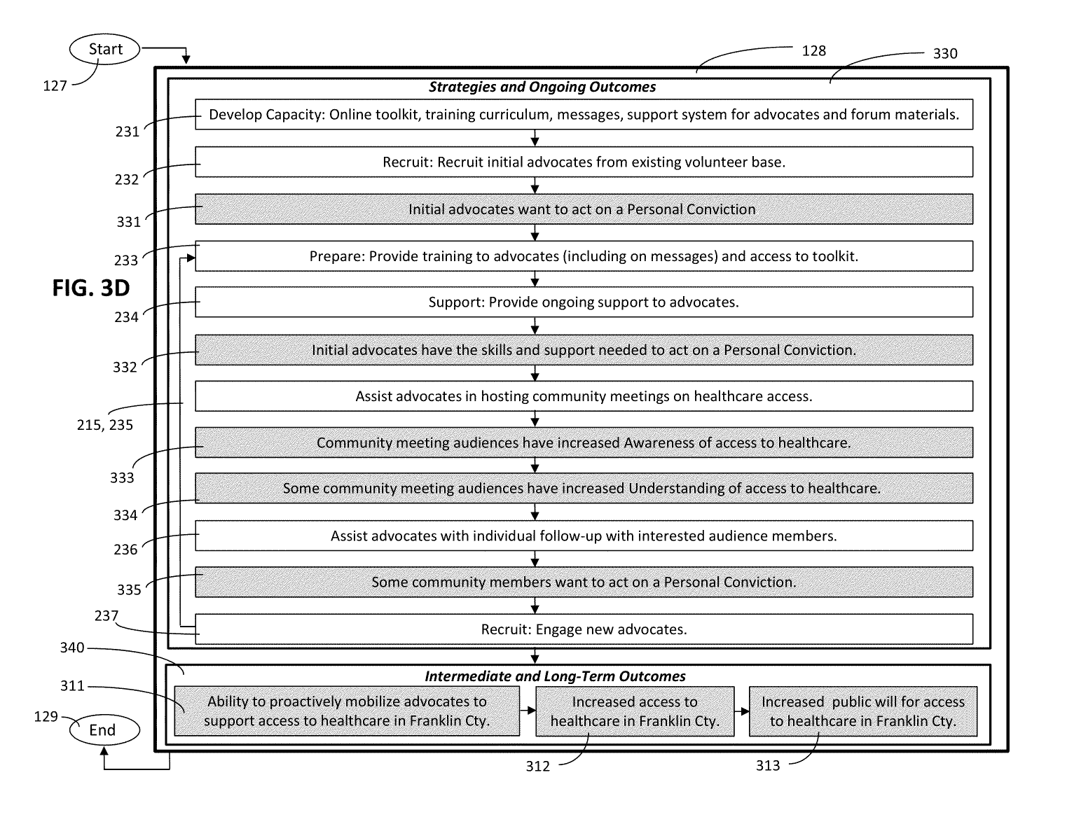

In the Learning Preparation Module 110, We Want Healthcare engaged a strategic learning coach who met with key staff and through dialogues determined that building public will for access to healthcare was the core element of their advocacy strategy. This allowed the coach to focus background work on finding a research-based framework that aligned with their approach to building public will. This framework was important as it provided the staff with clearly articulated and research-based assumptions about what their strategies could actually achieve. Next, We Want Healthcare entered the Roadmap Development Module 120 of FIG. 2. The Roadmap Development Module 120 of FIG. 2 is sequentially discussed in greater detail through FIGS. 3A-C.

With reference to FIG. 3A, We Want Healthcare generally proceeded through a sequence of sub-steps within the larger Roadmap Development Module 120, as detailed in FIG. 3A. The Roadmap Development Module 120 may be detailed as proceeding throu a Start Step of Roadmap Development Module 121, a Determine Nominal Strategies and Outcomes Step 122, a Refine Nominal Strategies and Outcomes Step 125, a Create Roadmap Integrating Strategies and Outcome Step 128 and an End Step of Roadmap Development Module 123.

In the Determine Nominal Strategies and Outcomes Step 122, We Want Healthcare went through a modified Theory of Change style process (i.e. a Roadmap development process) with a strategic learning coach after they decided on their core activities, found funders willing to support those activities, and even started implementing the first few. With the afore-mentioned strategic learning coach, they found themselves articulating why their work mattered for the first time. They decided to focus their Roadmap process and their strategic learning on activities that were relatively new to their organization. In the past, they had done lobbying and educational activities, but this was the first time they had tried to develop a network of advocates to carry their message. The session began with all of their current activities presented on the wall using large sticky notes. Also on the wall were the set of outcomes they promised funders they would achieve. The Nominal Strategies Set 210 is depicted on FIG. 3B, with set of five nominal strategies, i.e. Nominal Strategy One 211, Nominal Strategy Two 212, Nominal Strategy Three 213, Nominal Strategy Four 214 and Nominal Strategy Five 215. Also depicted on FIG. 3B is a Nominal Outcomes Set 310 with associated set of three nominal outcomes Nominal Outcomes One 311, Nominal Outcomes Two 312 and Nominal Outcomes Three 313.

During the next two hours, the participants (program staff) and the facilitator (strategic learning coach) explored the research-based framework brought by the coach. (This is the Refine Nominal Strategies and Outcomes Step 125 of FIG. 3A, as shown in greater detail as FIG. 3C). Using that framework, they discussed the strategies and outcomes posted on the wall from both directions. Sometimes the dialogue focused on the end-of-the-road question: If you envision increased access to healthcare in the county, what changes need to happen before that can occur? This resulted in their three outcomes being sequenced—from increased ability to proactively mobilize to increased public will to increased access to healthcare. Participants also realized they had made some jumps in their thinking, from having new advocates to the successful building of public will for access to healthcare. From the research-based framework, they understood that in order to build will, they needed to first build awareness, cause people to want to learn more about the issue and understand it better, and build the number of people with a personal conviction to act on the issue. This realization caused them to create a longer chain of outcomes that added three more to the original three. That is, the Nominal Outcomes Set 310 of FIG. 3B was expanded, as shown in FIG. 3C, to include six outcomes rather than three, as depicted as Refined Outcomes Set 320. Refined Outcomes Set 320 includes six outcomes, i.e. Refined Outcomes One 331, Refined Outcomes Two 322, Refined Outcomes Three 323 and the existing Nominal Outcomes One 311, Nominal Outcomes Two 312 and Nominal Outcomes Three 313. Note that the Refine Nominal Strategies and Outcomes Step 125 of FIG. 3A begins with Start Step of Refine Nominal Strategies and Outcomes 124 and ends with End Step of Refine Nominal Strategies and Outcomes 126.

The dialogue also focused on the beginning of the road and how the activities they had already identified would assist them in building public will. From the research-based framework, they better understood the cycle they were attempting to create—building awareness, sharing new information, recruiting new advocates who would then build awareness, share new information, and recruit their own new advocates.

By the Roadmap meeting's end, participants came to a collective agreement that while their originally envisioned activities were still appropriate, the focus on building a core group of advocates who would engage in a variety of advocacy activities would not achieve their desired goal of building public will. Instead, they shifted their focus to supporting advocates to recruit more advocates, while also building awareness and sharing new information on access to healthcare with community members.

In addition to discussing their own strategy, participants checked in to confirm their assumptions that they and their partners were addressing the policy and political dynamics of access to healthcare outside of advocate recruitment. While public will for access to healthcare was their focus, they chose not to include on their Roadmap visual, but strongly agreed with, the concept that public will had to be aligned with political will and concrete policy strategies. As a group, they agreed to continue to explore that alignment, which included looking at their other organizations to see where they could establish formal connections between recruiting advocates and developing political will and policy alternatives.

The resulting final adapted and specialized Roadmap is depicted as FIG. 3D, which begins with Start Step of Create Roadmap Integrating Strategies and Outcome 127 and ends with End Step of Create Roadmap Integrating Strategies and Outcome 129.

We Want Healthcare then moved into the Focused Learning Module 160 as shown in FIG. 2. Specifically, We Want Healthcare used the specialized and adapted Roadmap of the Roadmap Development Module 120 as discussed above to focus their strategic learning. In the weeks after the Roadmap meeting, We Want Healthcare explored their strategies and started refining them to focus more on the changes they hoped to cause. They shifted their advocacy toolkit to focus more specifically on building public will rather than on general advocacy strategies. They shifted their training to focus on community forums, messaging, and recruiting new advocates. They also started the conversation on how to use strategic learning to improve the quality of their activities.

In looking at the outcomes on their Roadmap, they identified key opportunities for strategic learning to improve implementation of their activities and outcomes:
1. Don't assume the initial advocates (recruited from volunteers) have a personal conviction for access to health. Learn from them about where they are starting. Also learn what caused them to want to get more involved. Is there something We Want Healthcare could do to engage their current volunteers even more?
2. Test the messaging. Does it resonate with community members? Who does it resonate with most? Forums could target these audiences.
3. Evaluate the training before the forums start. Did it build the necessary skills and confidence for advocates to host forums and recruit others?
4. Evaluate the forums' implementation. Did they run smoothly, who took on what roles, and did all those roles work? Did recruitment strategies result in audiences who responded to the message? Why or why not? Were the messages used?
5. Evaluate participants at forums to see if they report better understanding of access to healthcare issues and a personal conviction to stay involved. Use results to improve forums and target community members for individual follow-ups.
6. Develop, field-test, and revise tools for advocates to use as they do community member follow-ups to recruit new advocates.

Some of these learning strategies were about the external environment (whether the volunteers they assumed would have conviction did, in fact, have conviction). Others were about the quality of implementation (whether forums ran smoothly, tools for advocates to use). Finally, others were more evaluative and focused on outcomes (training outcomes, forum outcomes). Overall, they designed their strategic learning to ensure they would learn enough at each stage of their work to know if they were ready to move to the next step.

We Want Healthcare then moved into the Data Collection Module 170 as shown in FIG. 2. More specifically, six months into their strategy, We Want Healthcare had completed their first round of advocate recruiting, training, and community forums. They decided to treat the first round like a pilot and put in place extensive opportunities for strategic learning in order to ensure their second round would benefit from their learning. They also planned to back off their strategic learning activities once they had a high-quality strategy in place.

As part of their strategic learning, they surveyed all volunteers prior to the first round of recruiting to better understand their level of conviction and how to best recruit them into activities. The survey was short, not open for long, and the response rate low, but they did learn which healthcare access issues motivated volunteer respondents. They used this information in their recruitment flyers and got an initial group of 24 volunteers.

The organization did two focus groups on messaging prior to training advocates. After the first, they tweaked their message to be less focused on healthcare system reform and more on individual healthcare access. After the second focus group they finalized the message and developed their messaging tools.

Pre- and post-tests of advocates' skills and confidence were conducted as they went through the training Advocates also participated in a messaging focus group on the training's last day in which their readiness to use messages verbally was explored. In response to the finding that advocates were not yet ready, an additional messaging training was held within the next month.

At each community forum, participants completed “reflections” on their experiences and interest in being involved in additional access to healthcare activities. A staff member from We Want Healthcare used a structured observation tool at each forum to assess advocate message use and audience response, and collected audience feedback verbally after the forum. After the first three community forums, the staff and advocates did an intense period debrief to explore implementation and revise it in time for the next round of forums. They realized they had to rethink their press release and flyer approach to recruitment, as most participants were already health advocates in the community. The goal of engaging new advocates might not be possible if they only got the “usual suspects” to their meetings. They used a more personalized strategy for recruitment in the next round of forums, with each advocate recruiting friends, family members, neighbors, members of their churches and activity groups, and colleagues.

Although they used the data gathered from all of the learning activities in real-time to refine their activities and ensure they were ready to move to the next stage, they also wanted to bring the results together and explore their overall approach before moving into recruiting and training community members. For this reason, they scheduled a Strategic Learning Debrief with their staff and key advocates and asked their strategic learning coach to facilitate. We Want Healthcare staff brought the majority of findings from their strategic learning process, with one exception. They hired an external evaluator to do the pre and post of the training and the focus group with advocates, so they asked the evaluator to participate and provide the results in a summarized format.

We Want Healthcare then moved into the Strategy Improvement Module 180 as shown in FIG. 2. Specifically, We Want Healthcare used and applied an adapted and specialized Strategic Learning Debrief to refine their strategies.

The facilitator began the Debrief with a review of the Roadmap, asking staff and advocates to talk about the strategies they had implemented in alignment with the Roadmap. Before moving on, the facilitator let the room discuss the Roadmap overall and ensure everyone was familiar and comfortable with it, as some advocates had not been present for its development.

The staff member who implemented the volunteer survey presented summarized survey results (generated by the online survey program). The advocates in the room talked about their experience taking the survey and the extent to which they felt the recruitment strategy built on the answers they provided. An advocate who had responded to the request for advocates, but had not answered the survey, explained that she felt the survey intent was not explained well in the initial email. The group agreed the survey should be revised and repeated to better target the next round of recruitment from their existing volunteers. In having this discussion, they realized one of their strategies would be to continue to recruit from their own base of volunteers, in addition to community members who attended forums.

The group then discussed the training and the forums. Rather than talk about one activity and then the other, they moved between them, exploring how skills the advocates developed (both by their own admission and as identified during the post-test) contributed or did not to the community forums. They reviewed the results of the reflections and discussed the high level of interest participants reported in staying involved in access to healthcare issues. In particular, they noted the level was high even among participants who reported no previous involvement on the issue. The facilitator paused the conversation to make sure everyone celebrated that accomplishment before they moved on to things that had not worked as well.

Next, they reviewed the results of the structured observation tool at the forum, which consistently reported that messages were not being used fully by advocates. They talked about the extra messaging training implemented after the focus group results and wondered why that had not been enough. One advocate pointed out that the message was long and hard to remember and he did not understand why it was important enough to be worth memorizing. In response, staff who managed the focus group talked about the results and how the personal healthcare access message resonated. The facilitator reminded the participants of the research-based framework they were using to understand building public will and how it focused on first building awareness. The participants found themselves with a potentially important question, but one that none could answer: Does having a common message help build awareness of a broader issue? Everyone agreed someone on the team needed to learn more about messaging to better understand what it could help them accomplish and whether they needed to invest more resources in building advocates' capacity and commitment to use the message.

Over the course of the three-hour meeting, participants discussed all components of their strategy that had been implemented, identified a set of changes in their strategies, and identified changes to their strategic learning tools. By the time they were done, changes to the strategy and learning included:
Updating the Roadmap to show ongoing recruitment of advocates from the existing base of volunteers
Revising and reissuing the volunteer survey
Meeting with a social marketing consultant to better understand what messaging can accomplish, whether it is critical to their strategy, and how to improve the use of it
Revising the pre- and post-test tools to focus on skills that had not been developed fully by the previous training, and refining the training related to those skills
Implementing the forums in the same manner as before, and only keeping the observation tool if messaging continued to be an issue
Moving forward with the individual follow-ups with community members who attended the forums to recruit them into trainings, along with implementing the field testing of tools advocates would use during these follow-ups.

The note taker captured changes to both organizational and strategic learning activities, along with the justifications for each change. These justifications included the research findings, such as the results of the observation tool, and the intuitive and experiential information provided by participants, such as the individual advocate's experience of being overwhelmed by the length and complexity of the message. This documentation was to help staff remember why the change was important and what needed to be changed.

Also, while the flowcharts have been discussed and illustrated in relation to a particular sequence of events, it should be appreciated that changes, additions, and omissions to this sequence can occur without materially affecting the operation of the disclosed embodiments, configuration, and aspects.

A number of variations and modifications of the disclosure can be used. It would be possible to provide for some features of the disclosure without providing others.

In yet another embodiment, the disclosed methods may be partially implemented in software that can be stored on a storage medium, executed on programmed general-purpose computer with the cooperation of a controller and memory, a special purpose computer, a microprocessor, or the like. In these instances, the systems and methods of this disclosure can be implemented as program embedded on personal computer as a resource residing on a server or computer workstation, as a routine embedded in a dedicated measurement system, system component, or the like. The system can also be implemented by physically incorporating the system and/or method into a software and/or hardware system.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and\or reducing cost of implementation.

The foregoing discussion has been presented for purposes of illustration and description. The foregoing is not intended to limit the disclosure to the form or forms disclosed herein. In the foregoing Detailed Description for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

To lend further clarity to the Detailed Description provided herein in the associated drawings, the following list of components and associated numbering are provided:

| Reference | |
|---|---|
| No. | Component |
| 10 | Strategic Learning General Model |
| 20 | Strategic Learning General Model Element One |
| 30 | Strategic Learning General Model Element Two |
| 40 | Strategic Learning General Model Element Three |
| 100 | Strategic Learning System |
| 105 | Start Step of Strategic Learning System |
| 110 | Learning Preparation Module |
| 120 | Roadmap Development Module |
| 121 | Start Step of Roadmap Development Module |
| 122 | Determine Nominal Strategies and Outcomes Step |
| 123 | End Step of Roadmap Development Module |
| 124 | Start Step of Refine Nominal Strategies and Outcomes |
| 125 | Refine Nominal Strategies and Outcomes Step |
| 126 | End Step of Refine Nominal Strategies and Outcomes |
| 127 | Start Step of Create Roadmap Integrating Strategies and |
| | Outcome |
| 128 | Create Roadmap Integrating Strategies and Outcome Step |
| 129 | End Step of Create Roadmap Integrating Strategies and |
| | Outcome |
| 160 | Focused Learning Module |
| 170 | Data Collection Module |
| 180 | Strategy Improvement Module |
| 195 | End Step of Strategic Learning System |
| 210 | Nominal Strategies Set |
| 211 | Nominal Strategy One |
| 212 | Nominal Strategy Two |
| 213 | Nominal Strategy Three |
| 214 | Nominal Strategy Four |
| 215 | Nominal Strategy Five |
| 231 | Roadmap Ongoing Outcome One |
| 232 | Roadmap Ongoing Outcome Two |
| 233 | Roadmap Ongoing Outcome Three |
| 234 | Roadmap Ongoing Outcome Four |
| 235 | Roadmap Ongoing Outcome Five |
| 236 | Roadmap Ongoing Outcome Six |
| 237 | Roadmap Ongoing Outcome Seven |
| 310 | Nominal Outcomes Set |
| 311 | Nominal Outcome One |
| 312 | Nominal Outcome Two |
| 313 | Nominal Outcome Three |
| 320 | Refined Outcomes Set |
| 321 | Refined Outcome One |
| 322 | Refined Outcome Two |
| 323 | Refined Outcome Three |
| 330 | Roadmap Strategies and Ongoing Outcomes |
| 331 | Roadmap Strategy One |
| 332 | Roadmap Strategy Two |
| 333 | Roadmap Strategy Three |
| 334 | Roadmap Strategy Four |
| 335 | Roadmap Strategy Five |
| 340 | Roadmap Intermediate and Long-term Outcomes |

What is claimed is:

1. A method for strategic learning comprising:
preparing a strategic learning environment by assembling a learning team, identifying a plurality of initial strategies and initial outcomes, and reviewing existing research relative to the initial strategies;
developing a strategic learning roadmap by refining the initial strategies and initial outcomes based on at least the existing research and through use of the learning team, wherein refined strategies and refined outcomes are created;
focusing the roadmap by identifying at least one refined outcome as a critical outcome;
collecting data, the data at least comprising a measure of at least one critical outcome; and
interpreting the data by assessing the data through use of the learning team, wherein at least one of the refined strategies of the strategic learning roadmap may selectably be further refined.

2. The method of claim 1, wherein the step of interpreting the data occurs at least at one of an on-going basis, predefined items linked to milestones, and regular intervals.

3. The method of claim 1, wherein the step of interpreting the data occurs at least at two of an on-going basis, predefined items linked to milestones, and regular intervals.

4. The method of claim 1, wherein the at least one refined outcome is a plurality of refined outcomes and the critical outcome is a plurality of critical outcomes.

5. The method of claim 1, wherein the at least one of the refined strategies is further refined.

6. The method of claim 1, wherein the step of interpreting the data further comprises a strategic learning debrief.

7. The method of claim 1, wherein the roadmap is used to identify the data.

8. The method of claim 6, wherein the roadmap is used to guide the strategic learning debrief.

9. The method of claim 1, wherein at least one of the plurality of initial strategies comprises achieving a social good.

10. A system for strategic learning comprising:
a strategic learning module wherein a learning team is assembled, a plurality of initial strategies and initial outcomes are identified, and existing research relative to the initial strategies are reviewed;
a roadmap development module wherein a strategic learning roadmap is developed, the roadmap comprising refined initial strategies and refined initial outcomes based on the existing research, wherein the refined strategies and refined outcomes are created;
a focused learning module wherein at least one refined outcome as a critical outcome is identified;
a data collection module wherein data is collected, the data at least comprising a measure of at least one critical outcome; and
a strategy improvement module wherein interpreting the data is assessed through use of the learning team and a strategic learning debrief, wherein at least one of the refined strategies of the strategic learning roadmap is further refined.

11. The system of claim 10, wherein interpreting the data occurs at least at one of an on-going basis, predefined items linked to milestones, and regular intervals.

12. The system of claim 10, wherein interpreting the data occurs at least at one of an on-going basis, predefined items linked to milestones, and regular intervals.

13. The system of claim 10, wherein interpreting the data occurs at least at two of an on-going basis, predefined items linked to milestones, and regular intervals.

14. The system of claim 10, wherein the at least one refined outcome is a plurality of refined outcomes and the critical outcome is a plurality of critical outcomes.

15. The system of claim 10, wherein the at least one of the refined strategies is further refined.

16. The system of claim 10, wherein interpreting the data further comprises a strategic learning debrief.

17. The system of claim 10, wherein the roadmap is used to identify the data.

18. The system of claim 16, wherein the roadmap is used to guide the strategic learning debrief.

19. The method of claim 10, wherein at least one of the plurality of initial strategies comprises achieving a social good.

20. A method for strategic learning for a social good comprising:
preparing a strategic learning environment by assembling a learning team, identifying a plurality of initial strategies and initial outcomes, and reviewing existing research relative to the initial strategies;
developing a strategic learning roadmap by refining the initial strategies and initial outcomes based on at least the existing research and through use of the learning team, wherein refined strategies and refined outcomes are created;
focusing the roadmap by identifying at least one refined outcome as a critical outcome;
collecting data, the data at least comprising a measure of at least one critical outcome; and
interpreting the data by assessing the data through use of the learning team and through a strategic learning debrief, wherein at least one of the refined strategies of the strategic learning roadmap may selectably be further refined.
